(19) United States
(12) Patent Application Publication
(10) Pub. No.: US 2011/0082995 A1
(43) Pub. Date: Apr. 7, 2011

(54) INFORMATION PROCESSING APPARATUS

(75) Inventor: Hisashi Enomoto, Mishima-shi (JP)

(73) Assignee: CANON KABUSHIKI KAISHA, Tokyo (JP)

(21) Appl. No.: 12/893,392

(22) Filed: Sep. 29, 2010

(30) Foreign Application Priority Data
Oct. 6, 2009 (JP) 2009-232727

(51) Int. Cl. G06F 12/00

(52) U.S. Cl. 711/166; 711/E12.001

(57) ABSTRACT

An information processing apparatus includes a storage unit configured to include a plurality of storage areas, a receiving unit configured to receive updating data for updating data stored in the storage unit, and a control unit configured to update the data stored in the storage unit based on the received updating data, wherein when the receiving unit receives the updating data for updating a portion of data stored in a first storage area among the plurality of storage areas, the control unit deletes data stored in a second storage area among the plurality of storage areas, writes the data stored in the first storage area in the second storage area, deletes the data in the first storage area, and then updates the data in the first storage area using the updating data received by the receiving unit and the data written in the second storage area.

### BACKGROUND OF THE INVENTION

1. Field of the Invention

The present invention relates to an information processing apparatus capable of updating data.

2. Description of the Related Art

Conventionally, as a method for speeding up an operation for update data within a nonvolatile memory, updating data is transmitted as differential data, a system, in which a random access memory (RAM) has a larger area than an update unit of data of the nonvolatile memory is mounted, transmits differential data of the data to be updated. A method for speeding up an update job by creating updating data within the RAM and by updating data of the nonvolatile memory is discussed in Japanese Patent Application Laid-Open No. 10-171664.

However, in this method, the use of RAM with a larger area than the update unit of the data of the nonvolatile memory eventually becomes a factor in increasing a cost. Thus, in order to realize a low cost, there is an idea to make a capacity of the RAM smaller than the update unit of the data of the nonvolatile memory.

In a data update job in a system which includes only a RAM with a small area, updating data cannot be created within the RAM. In such a case, updating of data is performed by once deleting all pieces of data in the nonvolatile memory, sequentially receiving the updating data for each area of the RAM, and sequentially writing the received data into the nonvolatile memory. In this method, all pieces of the data to be written into the nonvolatile memory need to be received, and accordingly time required for the RAM to receive the data became longer, so that time to perform update operation also becomes longer.

### SUMMARY OF THE INVENTION

The present invention relates to shortening time to update data, even in a system which includes only a RAM with a small capacity for updating data of a nonvolatile memory.

According to an aspect of the present invention, an information processing apparatus includes a storage unit configured to include a plurality of storage areas, a receiving unit configured to receive updating data for updating data stored in the storage unit, and a control unit configured to update the data stored in the storage unit based on the received updating data, wherein when the receiving unit receives the updating data for updating a portion of data stored in a first storage area among the plurality of storage areas, the control unit deletes data stored in a second storage area among the plurality of storage areas, writes the data stored in the first storage area in the second storage area, deletes the data in the first storage area, and then updates the data in the first storage area using the updating data received by the receiving unit and the data written in the second storage area.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIGS. 1A and 1B illustrate a configuration of a multi central processing unit (CPU) system as an information processing apparatus according to a first exemplary embodiment of the present invention.

FIGS. 2A and 2B illustrate program updating data according to the first exemplary embodiment.

FIG. 3 is a flowchart illustrating a method for creating program updating data in the first exemplary embodiment.

FIG. 4 is a flowchart illustrating a method for updating a program in the first exemplary embodiment.

FIG. 5 is a flowchart illustrating a method for updating a nonvolatile memory in the first exemplary embodiment.

FIG. 6 illustrates a method for updating a program in the first exemplary embodiment.

FIGS. 7A and 7B illustrate a configuration of a multi-CPU system as an information processing apparatus according to a second exemplary embodiment.

FIG. 8 is a flowchart illustrating a program update job in the second exemplary embodiment.

FIGS. 9A and 9B illustrate a configuration of a multi-CPU system as an information processing apparatus according to a third exemplary embodiment.

FIGS. 10A and 10B illustrate program updating data in the third exemplary embodiment.

FIG. 11 is a flowchart illustrating a method for determining a buffer sector for data backup in the third exemplary embodiment.

FIG. 12 is a flowchart illustrating a method for updating a program in the third exemplary embodiment.

### DESCRIPTION OF THE EMBODIMENTS

Various exemplary embodiments, features, and aspects of the invention will be described in detail below with reference to the drawings.

All of combinations of features described in exemplary embodiments are not necessarily essential for resolving means of the invention.

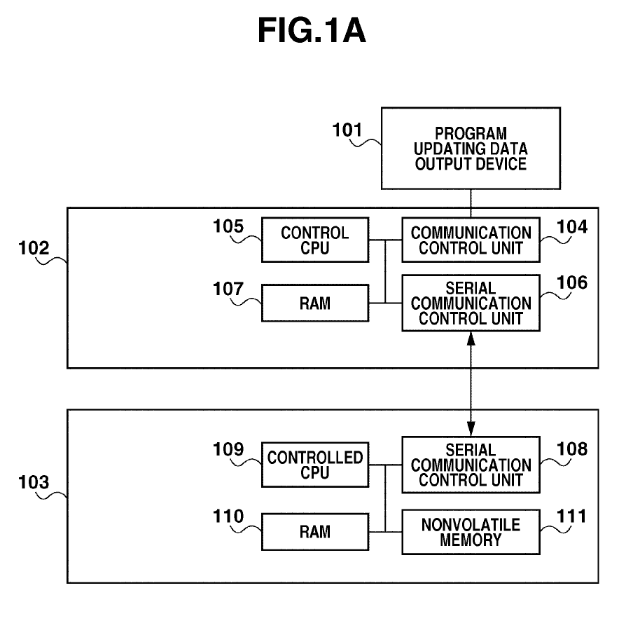

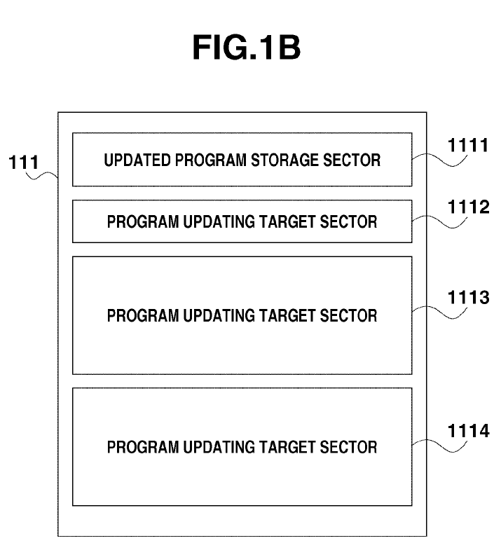

FIG. 1A illustrates a multi-CPU system as an information processing apparatus according to a first exemplary embodiment of the present invention. FIG. 1B illustrates a configuration of a nonvolatile memory 111 which includes a plurality of storage areas (hereinafter, referred to as sector). Contents of data to be updated, such as programs or parameters, can be set as appropriate according to a status of an apparatus adapted to the multi-CPU system. However, here, a case of updating a program will be described by way of example. Further, it is assumed that writing of data to the nonvolatile memory 111 in the present exemplary embodiment can be performed whenever necessary, but complete delete is only applicable to delete of the data.

The multi-CPU system will be described with reference to FIG. 1A. The multi-CPU system includes a program updating data output device 101, a controller 102 including a control CPU, and a controller 103 including a controlled CPU. The controller 102 including the control CPU includes a control CPU 105 and a RAM 107 whose capacity is larger than that of the nonvolatile memory 111 performs communication with the program updating data output device 101 by a communication control unit 104. Further, the controller 102 uses a serial communication control unit 106 to perform serial communication with a serial communication control unit 108 of the controller 103 including the controlled CPU.

The controller 103 including the controlled CPU includes a controlled CPU 109, the nonvolatile memory 111 and a RAM 110 whose capacity is smaller than that of the nonvolatile memory 111. Further, the controller 103 performs serial communication with the controller 102 including the control CPU by the serial communication control unit 108, and updates the nonvolatile memory 111.

A configuration of the nonvolatile memory 111 will be described with reference to FIG. 1B. The nonvolatile memory 111 includes an updated program storing sector 1111 which is not rewritable, and program updating target sectors 1112, 1113, and 1114 which are rewritable. An operation program during updating a program of the controlled CPU 109 is stored in the updated program storing sector 1111.

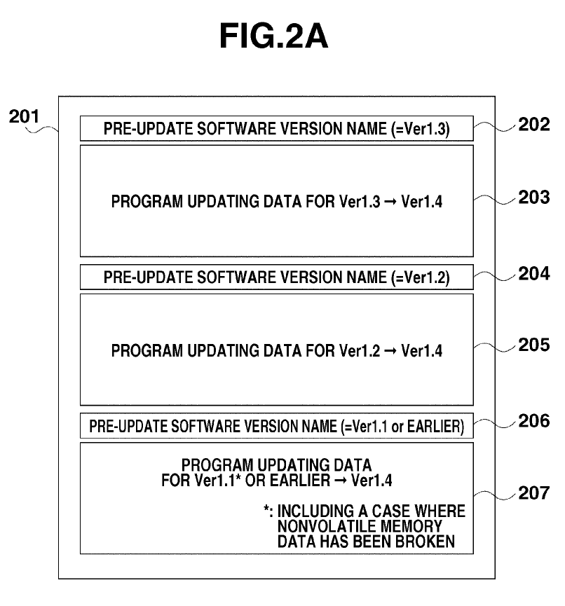

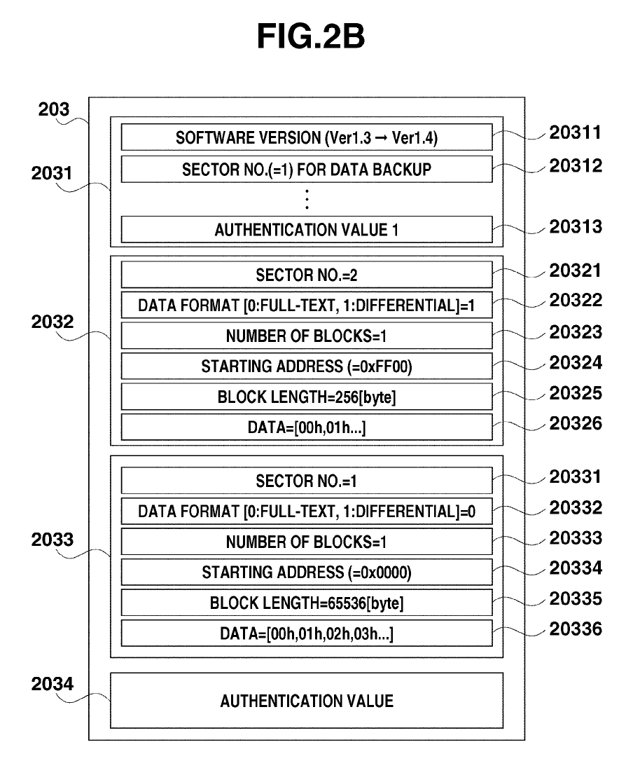

FIG. 2A illustrates an example of program updating data used for updating the program in the present exemplary embodiment. FIG. 2B illustrates an example of more specific configuration of the program updating data. Program updating data 201 is used for updating a version of software to Ver1.4. The program updating data 201 includes sectors 202, 204, and 206 indicating pre-update software version names, and program updating data pieces 203, 205, and 207 corresponding to each of the versions.

More specifically, the sector 202 indicates that pre-update version of the software is Ver1.3, and the sector 203 stores the program updating data for updating the software from Ver1.3 to Ver1.4 therein. Likewise, the sector 204 indicates that pre-update version of the software is Ver1.2, and the sector 205 stores the program updating data for updating the software from Ver1.2 to Ver1.4. The sector 206 indicates that pre-update version of the software is Ver1.1 or earlier, and the sector 207 stores the program updating data for updating the software from Ver1.1 or earlier to Ver1.4.

FIG. 2B illustrates more specific configuration of the program updating data. The program updating data 203 for Ver1.3 is arranged such that a header 2031 comes at a head, an authentication value of the nonvolatile memory after updated comes at an end, and the sector not to be used as a buffer sector for data backup and the sector to be used as the buffer sector for data backup are arranged in this order in unit of sector of the nonvolatile memory.

The header 2031 includes a software version 20311 of the program before updating, a sector number 20312 to be used as the buffer sector for data backup during program update operation, and an authentication value 20313 for assuring that the header of the program updating data is not destroyed.

A sector 2032 includes a sector number 20321, a data format number 20322 indicating whether data for the sector is full text data or differential data, a number of data blocks 20323, a starting address of the block 20324, a data length of the block 20325, and data of the block 20326.

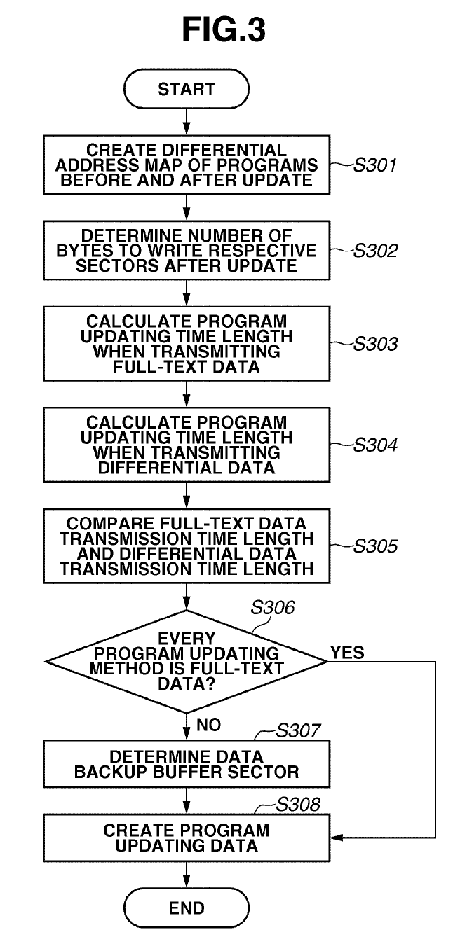

FIG. 3 is a flowchart illustrating a method for creating the program updating data. In step S301, the control CPU 105 compares programs before and after update, and creates an address map of locations where to be updated. In step S302, the control CPU 105 acquires a full text data size Sz1 of the program to be stored in the respective sectors after update, and a differential data size Sz2 in case where the differential data of the address map previously determined in step S301 is used.

In step S303, the control CPU 105 calculates time needed to perform program update at the time when the full text data is transmitted. Time Ta (ms) when the full text data is transmitted is calculated by the following equation (1), from time Te (ms) required for deleting the nonvolatile memory once, the full text data size Sz1 (byte), time Tw (ms/byte) required for data transmission, and time Tp (ms/byte) required for data writing.

Ta=Te+Sz1*(Tw+Tp) (1)

In step S304, the control CPU 105 calculates time needed to perform program update when differential data is transmitted. When a program is updated using the differential data, first, data of the buffer sector for data backup is deleted. Then, data of a rewrite target sector is copied to the buffer sector for backup, the data of the rewrite target sector is deleted, and finally the program updating data and the buffer sector for data backup are updated.

Accordingly, time Tb (ms) required for transmitting the differential data is calculated by the following equation (2), from the time Te (ms) required for deleting the nonvolatile memory once, the differential data size Sz2 (byte), the time Tw (ms/byte) required for the data transmission, and the time Tp (ms/byte) required for writing data.

Tb=2*Te+Tc*(2*Sz3−Sz2)+Sz2*(Tw+Tp) (2)

In step S305, the control CPU 105 compares the Ta and the Tb which are previously determined in steps S303 and S304 in each sector. If Ta<Tb, the control CPU 105 creates the program updating data using the full text data, and if Ta>Tb, creates the program updating data using the differential data.

In step S306, the control CPU 105 determines a number of sectors which require rewrite. Then, the control CPU 105 confirms an updating method for each sector. If the differential data is used for the updating method for either sector (NO in step S306), then in step S307, the control CPU 105 determines a sector in which Ta−Tb becomes minimum among sectors having a maximum sector size in the nonvolatile memory 111, and assigns the sector as a buffer sector for data backup 20312. This is because update of the data of the sector used as the buffer sector for data backup needs to receive and update all pieces of data irrespective of an update amount.

On the other hand, update of a sector which is not used as the buffer sector for data backup may need communication of only differential data on which update is performed. In other words, when a sector used as the buffer sector for data backup is assumed to be a sector which includes the greatest amount of updating data, reduction of an overall communication amount for data update can lead shortening of data update time. If the full text data is used in the updating method for any sector, (YES in step S306), then in step S307, the program updating data is created.

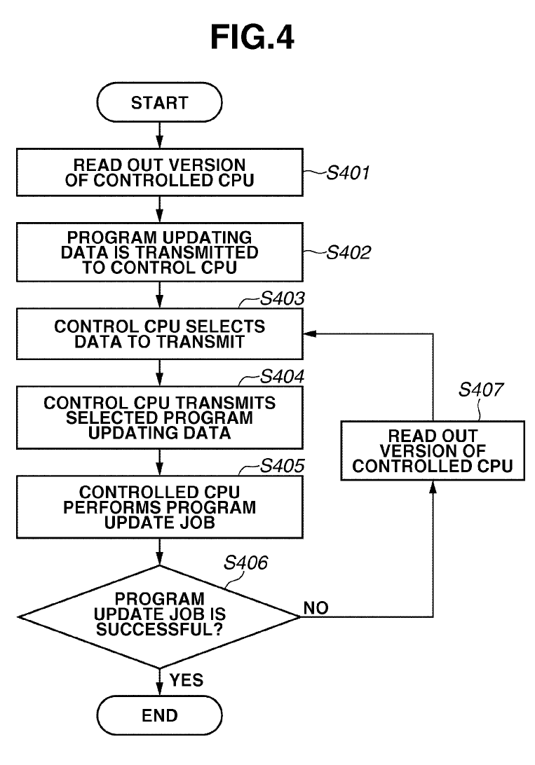

Next, a method for updating a program will be described with reference to the flowchart in FIG. 4. In step S401, the control CPU 105 reads out a version of software of the controlled CPU 109 from the nonvolatile memory 111, and then update of the program is started. In step S402, the program updating data 201 is transmitted using the communication control unit 104 to the control CPU 105 by the program updating data output device 101. The control CPU 105 stores the program updating data 201 in the RAM 107.

In step S403, the control CPU 105 selects the program updating data to be transmitted to the controlled CPU 109 according to the version of software of the controlled CPU 109 which has been read out in step S401. In step S404, the control CPU 105 sequentially transmits the program updating data selected in step S403 to the controlled CPU 109 using the serial communication control unit 106. The controlled CPU 109 receives the program updating data via the serial communication control unit 108 and stores the received data in the RAM 110.

In step S405, the controlled CPU 109 updates the nonvolatile memory 111 using the program updating data stored in the RAM 110. In step S406, the control CPU 105 checks whether a program update job is successful. If it is successful (YES in step S406), the control CPU 105 terminates the program update job. If not (NO in step S406), then in step S407, the control CPU 105 reads out again the version of software of the controlled CPU 109, and repeats the program update job from step S403.

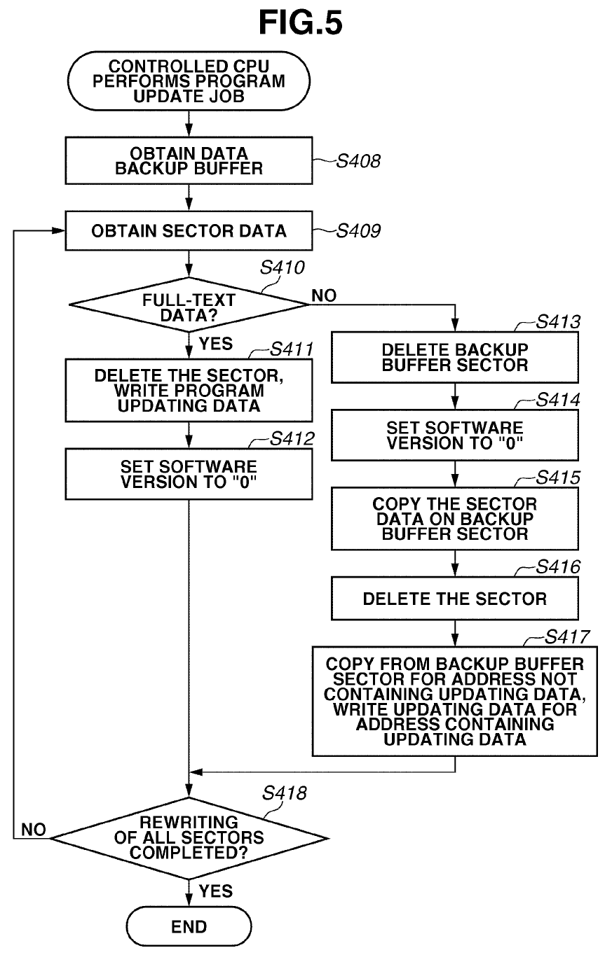

Next, a method for updating the nonvolatile memory 111 of the controlled CPU 109 will be described with reference to the flowchart in FIG. 5. In step S408, the controlled CPU 109 obtains the buffer sector number 20312 for data backup stored in the header unit 2031 of the program updating data 203.

In step S409, the controlled CPU 109 obtains the data 2032, 2033, and 2034 of each sector. Moreover, the controlled CPU 109 obtains the sector number 20321 and the data format 20322 in the sector. In step S410, the controlled CPU 109 determines whether the data format of the program updating data is the full text data or the differential data.

If the data format is the full text data (YES in step S410), then in step S411, the controlled CPU 109 deletes data in the sector corresponding to the sector number 20321, and sequentially receives the program updating data and writes the data into the sector. In step S412, the controlled CPU 109 sets the version of software to “0”.

If the data format is the differential data (NO in step S410), then in step S413, the controlled CPU 109 deletes the data in the sector corresponding to the buffer sector number 20312 for data backup. In step S414, the controlled CPU 109 sets the version of software to 0. In step S415, the controlled CPU 109 copies the data in the sector corresponding to the sector number 30321 to be updated onto the buffer sector for data backup. In step S416, the controlled CPU 109 deletes the data in the sector in which the program is updated. In step S417, the controlled CPU 109 writes the data into the sector in which the program is updated using pre-update program data created in step S415 and the program updating data to be transmitted in sequence. More specifically, addressing program data which has not received the program updating data is written from the buffer sector for data backup, and addressing program data which has received the program updating data is written from the RAM 110.

In step S418, the controlled CPU 109 checks whether rewriting of all sectors in which the program is updated is completed. If the rewrite operation of all sectors is not completed (NO in step S418), then the processing returns to step S409, and continues update of the sectors.

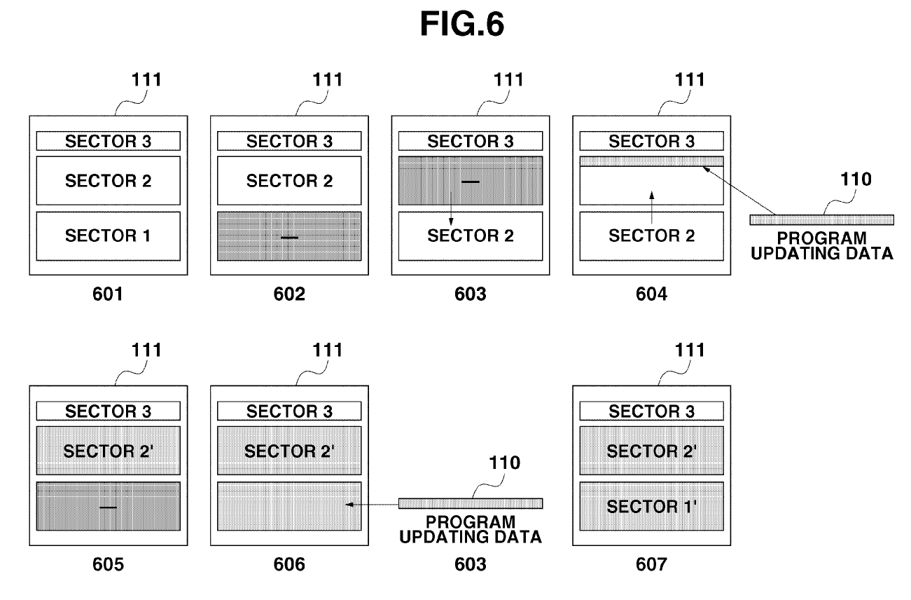

FIG. 6 illustrates a method for updating a program using differential data. It is assumed that the nonvolatile memory 111 includes sectors 1, 2, and 3, and programs of the sector 1 and the sector 2 are updated.

A state 601 indicates that pre-update programs are stored in the sectors 1, 2, and 3. A state 602 indicates that the data of the sector 1 is deleted in order to use the sector 1 as the buffer sector for data backup. A state 603 indicates that the sector 1 from which the data has been deleted is used as the buffer sector for data backup, and the data of the sector 2 is copied therein, then original data of the sector 2 is deleted.

A state 604 indicates that updated program is written into the sector 2 from which the data has been deleted. More specifically, as described above, the addressing program data of the program updating data stored in the RAM 110 is written from the RAM, and the addressing program data which is not stored as the program updating data is written from the data copied in the buffer sector for data backup. This process is repeated until all pieces of data of the sector 2 are written.

A state 605 indicates that update of the program of the sector 2 is completed, and data of the sector 1 which has been used as the buffer sector for data backup is deleted. A state 606 indicates that the program of the sector 1 is updated by the full text data. The RAM 110, upon receiving the program updating data of the sector 1, sequentially writes the received data into the sector 1. This process is repeated until all pieces of data of the sector 1 are written. A state 607 indicates that update of the program has been performed in both the sector 1 and the sector 2.

In this manner, when the program is updated, the differential data is transmitted according to an update amount of the program, so that a data communication amount can be made smaller than a case where the full text data is sent. Accordingly, necessary time for data communication can be reduced, and when the program is updated, necessary time for updating data can be shortened by selecting whether to use the full text data or the differential data. Hence, when only a part of the program is updated, update time can be shortened since there is no need for communication to parts of the program which are not updated.

In the first exemplary embodiment, it is described a case where the program updating data is transmitted from the control CPU 105 which includes a large-capacity RAM 107. In a second exemplary embodiment, a case when the control CPU which does not include a large-capacity RAM is connected is described. The configuration similar to that in the first exemplary embodiment can be similarly realized in the present exemplary embodiment, and thus detailed descriptions thereof will be omitted. Further, the program updating data can use similar configuration to that in the first exemplary embodiment illustrated in FIG. 2, and a method for creating the program updating data can use similar method to that illustrated in FIG. 3, and thus descriptions thereof will be omitted.

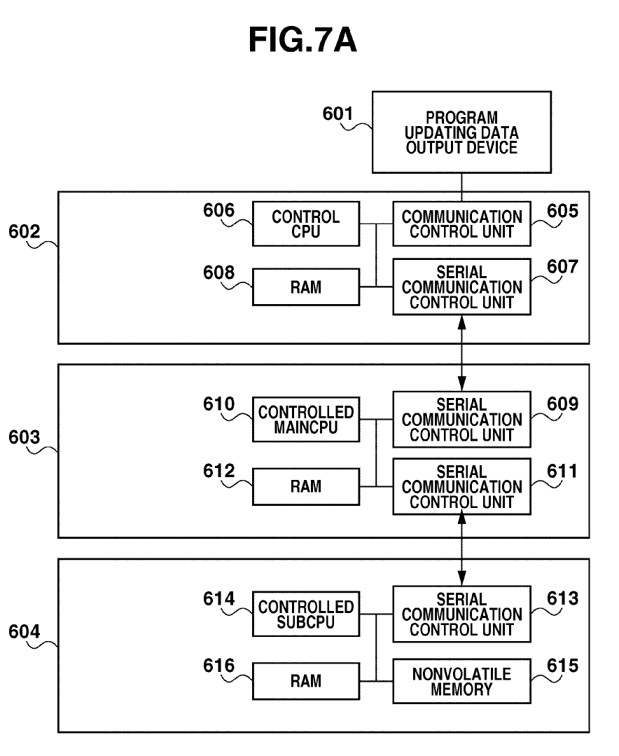

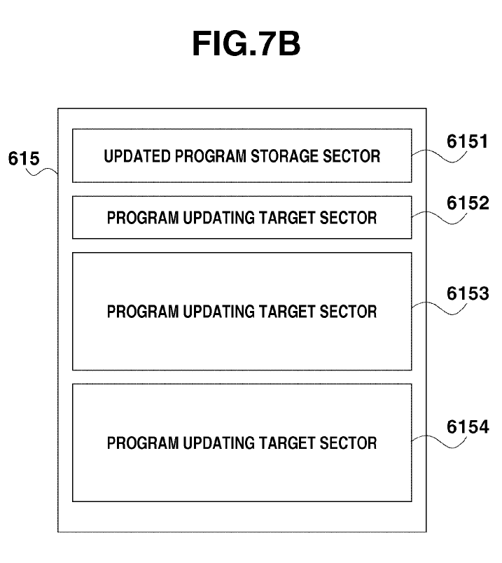

FIG. 7A illustrates a multi-CPU system as an information processing apparatus according to the present exemplary embodiment. FIG. 7B illustrates a configuration of a nonvolatile memory 615.

The multi-CPU system will be described with reference to FIG. 7A. The multi-CPU system includes a program updating data output device 601, a controller 602 including a control CPU, a controller 603 including a controlled MAINCPU, and a controller 604 including a controlled SUBCPU. The controller 602 including the control CPU includes a control CPU 606 and a RAM 608 having a capacity larger than that of the nonvolatile memory 615, and performs communication with the program updating data output device 601 by a communication control unit 605. The controller 602 further performs communication with a serial communication control unit 609 of the controller 603 including the controlled MAINCPU by a serial communication control unit 607.

The controller 603 including the controlled MAINCPU includes a MAINCPU 610 and a RAM 612 having a capacity smaller than that of the nonvolatile memory 615. Further, the controller 603 performs serial communication with the controller 602 including the control CPU by the serial communication control unit 609, and performs serial communication with the serial communication control unit 613 of the controller 604 including the controlled SUBCPU by the serial communication control unit 611.

The controller 604 including the controlled SUBCPU includes a SUBCPU 614 and a RAM 616 having a capacity smaller than that of the nonvolatile memory 615. Further, the controller 604 performs serial communication with the controller 603 including the controlled MAINCPU by the serial communication control unit 613, and updates the nonvolatile memory 615.

The configuration of the nonvolatile memory 615 in FIG. 7B is similar to that in FIG. 1B, and thus descriptions thereof will be omitted.

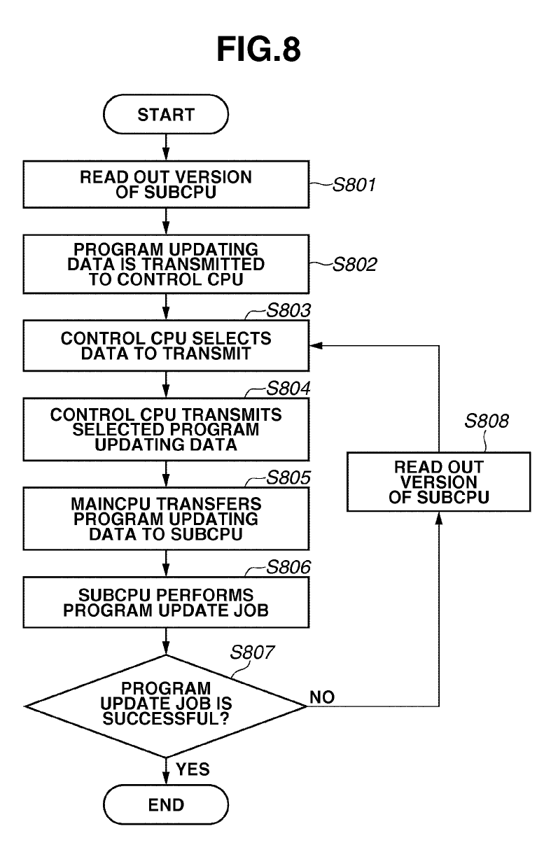

A method for updating a program will be described with reference to a flowchart in FIG. 8. In step S801, the controlled MAINCPU 610 reads out a version of software of the controlled SUBCPU 614 from the nonvolatile memory 615. Then, the control CPU 606 reads out the version of software of the controlled SUBCPU 614 from the controlled MAINCPU 610, so that update of the program is started.

In step S802, program updating data 701 is transmitted by the program updating data output device 601 to the control CPU 606 using the communication control unit 607. The control CPU 606 stores the program updating data in the RAM 608.

In step S803, the control CPU 606 selects the program updating data to be transmitted to the controlled MAINCPU 610, according to the version of software of the controlled SUBCPU 614 read out in step S801.

In step S804, the control CPU 606 sequentially transmits the program updating data 704 selected in step S803 to the controlled MAINCPU 610 using the serial communication control unit 607. The controlled MAINCPU 610 receives the program updating data via the serial communication control unit 609, and stores the received data in the RAM 612.

In step S805, the controlled MAINCPU 610 transfers the program updating data to be sequentially stored in the RAM 612 to the controlled SUBCPU 614 using the serial communication control unit 611. The controlled SUBCPU 614 receives the program updating data via the serial communication control unit 613, and stores the received data in the RAM 616.

In step S806, the controlled SUBCPU 614 updates the nonvolatile memory 615 using the program updating data which is sequentially stored in the RAM 616.

In step S807, the control CPU 606 checks whether program update job is successful. If it is successful (YES in step S807), the control CPU 606 terminates the program update job. If not (NO in step S807), then in step S808, the control CPU 606 reads out again the version of software of the controlled SUBCPU 614, and repeats the program update job from step S804.

A method for updating the nonvolatile memory 615 of the controlled SUBCPU 614 is similar to the method described in FIG. 5 in the first exemplary embodiment, and thus descriptions will be omitted.

In this manner, when the program is updated, in a situation where the program updating data needs to be communicated a plurality of times, much time will be required for data communication. In such a situation, by using the full text data and the differential data depending on the situation, an amount of communication of the program updating data can be reduced, and accordingly necessary time for update can be shortened. Hence, when only a part of the program is updated, update time can be shortened since there is no need for communication to parts of the program which are not updated.

In the first exemplary embodiment and the second exemplary embodiment, a method for updating a program using a certain sector in the nonvolatile memory as the buffer sector for data backup is described. By utilizing the buffer sector for data backup, a communication amount of updating the program can be reduced, and reduction of update time can be realized. However, a number of times of writing data may be different among the sectors in the nonvolatile memory by using the buffer sector for data backup.

If the same sector is used as the buffer sector for data backup every time the program is updated, the number of times of writing is increased in only the sector used as the buffer sector for data backup. Generally, there is a guaranteed number of times of writing in the nonvolatile memory, so that if writing operations are repeated on the same sector, there is a possibility that the sector may exceeds the guaranteed number of times of writing earlier than other sectors.

In a third exemplary embodiment, a method for updating a program in consideration of the guaranteed number of times of writing in a sector will be described.

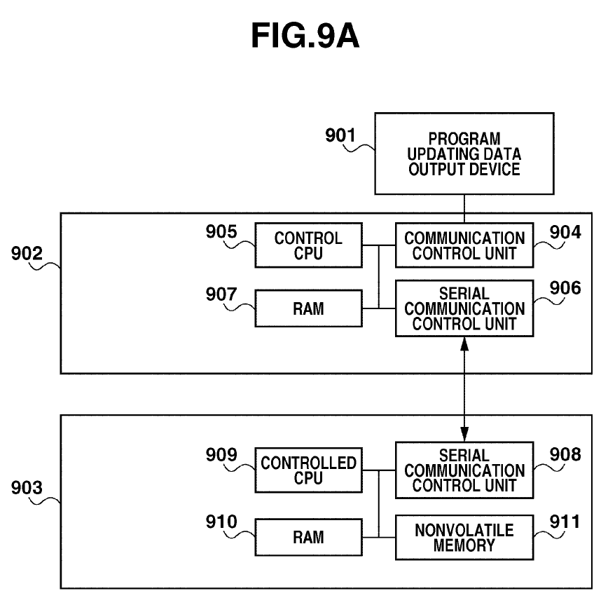

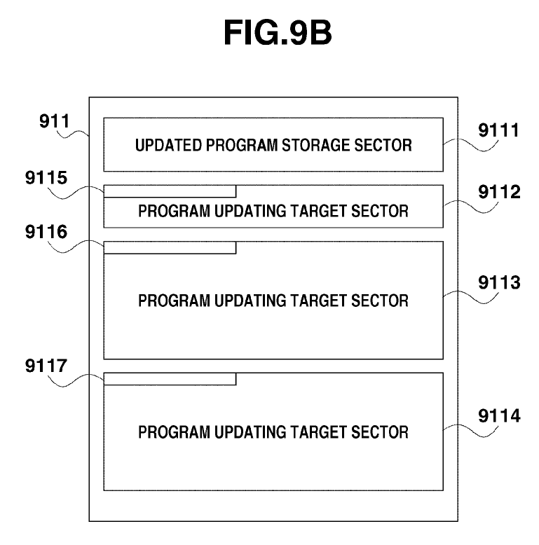

FIG. 9A illustrates a multi-CPU system as an information processing apparatus according to the present exemplary embodiment. FIG. 9B illustrates a configuration of a nonvolatile memory 911. The multi-CPU system in FIG. 9A is similar to the configuration previously described in the first exemplary embodiment illustrated in FIG. 1A, and thus descriptions thereof will be omitted.

A configuration of the nonvolatile memory 911 will be described with reference to FIG. 9B. Here, only configuration which is different from that in the first exemplary embodiment illustrated in FIG. 1B will be described. Program update target sectors 9112, 9113, and 9114 include counters 9115, 9116, and 9117 which store a number of times of writing in the respective sectors. Each counter increments the number of times of writing by one each time the write operation is performed on the sector.

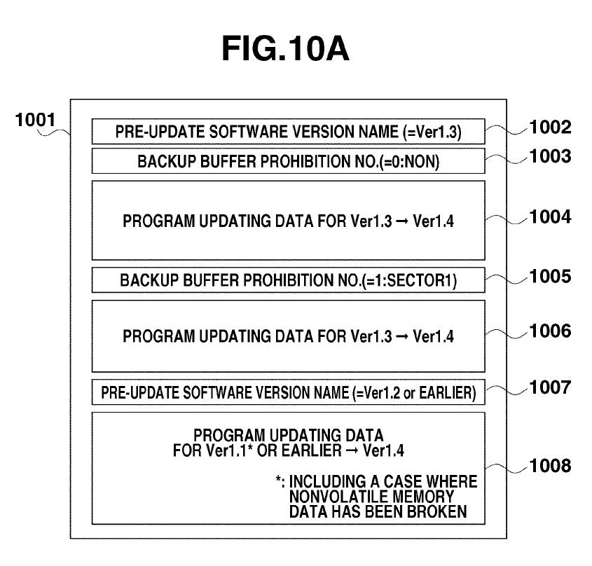

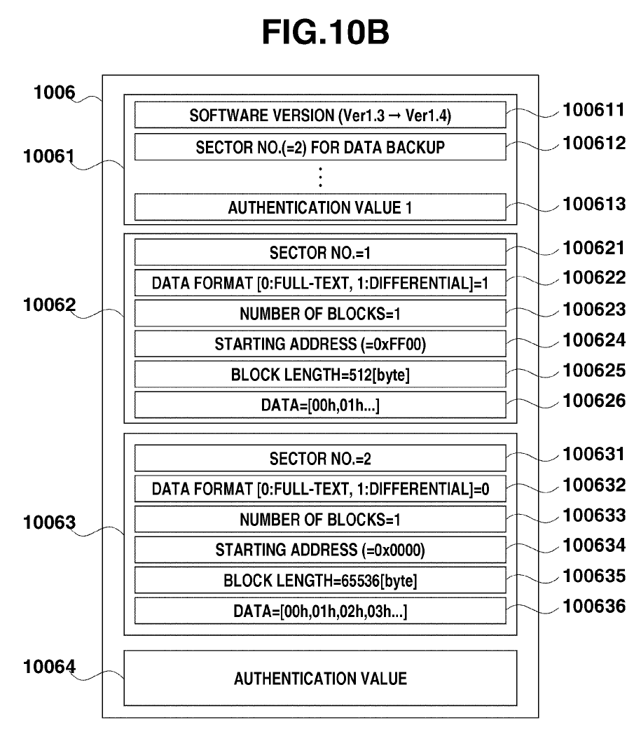

FIG. 10A illustrates an example of program updating data to be used in program update in the present exemplary embodiment. FIG. 10B illustrates an example of more specific configuration of the program updating data. Herein, a configuration which differs from that of the above described first exemplary embodiment illustrated in FIGS. 2A and 2B will be described. Sectors 1003 and 1005 store numbers of the sector which is prohibited from being used as the buffer sector for data backup. The sector of which number is stored in the sectors 1003 and 1005 is not used as the buffer sector for data backup, so that the number of times of writing can be prevented from biasing toward a certain sector.

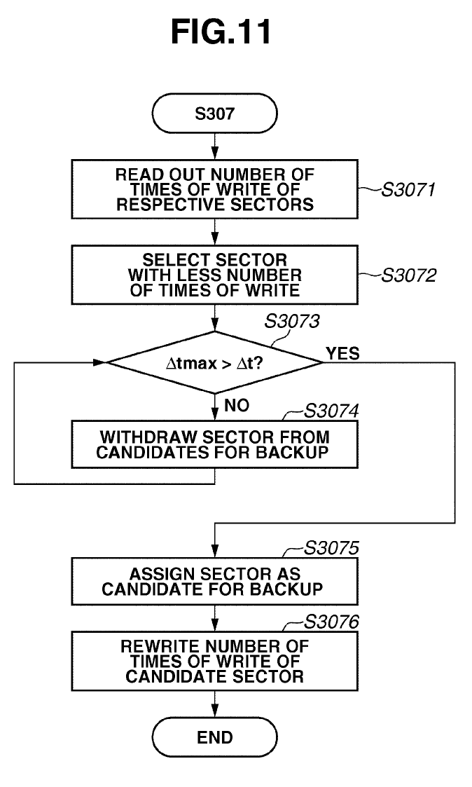

A method for determining a buffer sector for data backup will be described with reference to the flowchart in FIG. 11. A method for creating the program updating data is similar to that in the first exemplary embodiment illustrated in FIG. 3. The flowchart in FIG. 11 is used when the buffer sector for data backup is determined in step S307 in FIG. 3.

In step S3071, the control CPU 905 reads out the numbers of times of writing which has been performed in each sector up to the present time. In step S3072, the control CPU 105 compares the number of times of writing of each of the sectors, and selects a sector which has the smallest number of times of writing. In step S3073, the control CPU 105 compares Δt and Δtmax. Δt is time when the program is updated on the sector which has the smallest number of times of writing as the buffer sector for data backup, and Δtmax is time when Ta−Tb becomes maximum.

If Δt is larger that Δtmax (NO in step S3073), then in step S3074, the control CPU 905 withdraws the selected sector from a candidate for the buffer sector for data backup, and selects a sector with the second smallest number of times of writing, and then the processing returns to step S3073.

In step S3073, if Δt is smaller than Δtmax (YES in step S3073), then in step S3075, the control CPU 905 assigns the selected sector as the buffer sector for data backup. In step S3076, the control CPU 105 rewrites the number of times of writing of the sector determined to be used as the buffer sector for data backup in step S3075 with the number of times after having been used as the buffer sector for data backup.

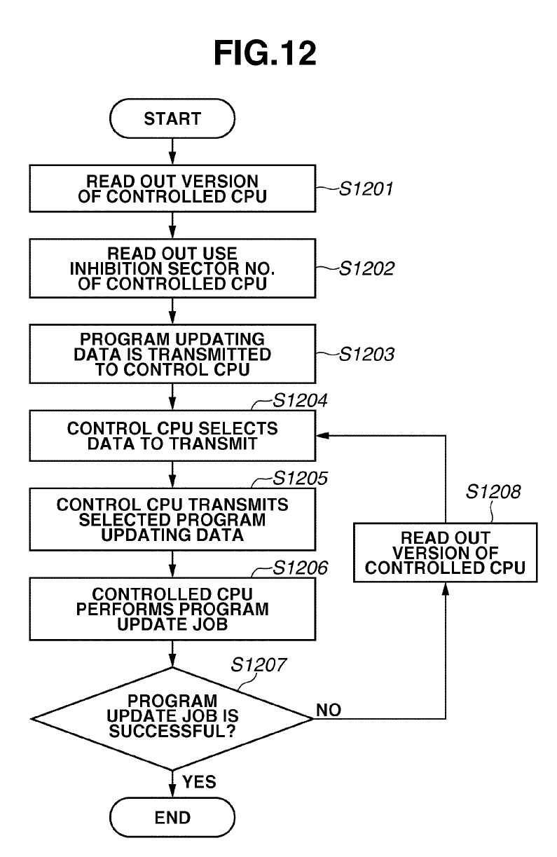

A method for updating a program will be described with reference to the flowchart in FIG. 12. Herein, steps which are different from the flowchart in the first exemplary embodiment illustrated in FIG. 4 will be described.

In step S1201, the control CPU 905 reads out the version of the controlled CPU. Then, in step S1202, the control CPU 905 reads out a number of the sector which is prohibited to be used as the buffer sector for data backup. The controlled CPU 909 prohibits the sectors in which values of data addresses 9115, 9116, and 9117 are equal to or greater than a specified value from being used as the buffer sectors for data backup. The values of data addresses 9115, 9116, and 9117 indicate the number of times of writing of respective sectors on the nonvolatile memory 911.

A sector whose number of times of writing is greater than those of other sectors is not used as the buffer sector for data backup. The subsequent update processing is similar to the processing in the first exemplary embodiment illustrated in FIG. 4 and FIG. 5, and thus descriptions thereof will be omitted.

As described above, according to the present exemplary embodiment, the sector whose number of times of writing is greater than those of other sectors is not used as the buffer sector for data backup. Thus, it can be prevented that the number of times of writing is increased on a certain sector and a lifetime of the nonvolatile memory is shortened. In addition, similarly to the above described exemplary embodiments, necessary time for updating the data can be shortened by selecting whether to use the full text data or the differential data.

Hence, when only a part of the program is updated, update time can be shortened since there is no need for communication to parts of the program which are not updated.

It is possible to combine a condition that a sector including a large amount of updating data is used as the buffer sector for data backup as described in the previous exemplary embodiments and a condition that a sector whose number of times of writing is large is not used as the buffer sector for data backup described in the present exemplary embodiment.

For example, when a sector including the greatest amount of updating data exceeds a threshold value of the number of times of writing, among the remaining sectors which do not exceed the threshold value of the number of times of writing, a sector including the greatest amount of the updating data can be used as the buffer sector for data backup.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-232727 filed Oct. 6, 2009, which is hereby incorporated by reference herein in its entirety.

What is claimed is:

1. An information processing apparatus comprising:
a storage unit configured to include a plurality of storage areas;
a receiving unit configured to receive updating data; and
a control unit configured to update data stored in the storage unit based on the received updating data,
wherein when the receiving unit receives the updating data for updating a portion of data stored in a first storage area among the plurality of storage areas, the control unit deletes data stored in a second storage area among the plurality of storage areas, writes the data stored in the first storage area in the second storage area, deletes the data in the first storage area, and then updates the data in the first storage area using the updating data received by the receiving unit and the data written in the second storage area.

2. The information processing apparatus according to claim 1, wherein the control unit deletes the data in the second storage area after updating the data of the first storage area, receives updating data of the second storage area using the receiving unit, and then updates the data of the second storage area using the received updating data of the second storage area.

3. The information processing apparatus according to claim 1, wherein the control unit uses a storage area in which an amount of updating data greater than an amount of updating data of the first storage area as the second storage area for writing the data of the first storage area.

4. The information processing apparatus according to claim 1, wherein the control unit uses a storage area in which a number of times of writing is less than a threshold value as the second storage area for writing the data of the first storage area.

5. The information processing apparatus according to claim 1, wherein the control unit uses a storage area in which a number of times of writing is less than a threshold value and which includes the greatest amount of updating data as the second storage area.

6. The information processing apparatus according to claim 1, wherein when the receiving unit receives updating data for updating all pieces of data stored in the first storage area, the control unit deletes the data stored in the first storage area and then writes the updating data received by the receiving unit in the first storage area.
